(19) United States
(12) Patent Application Publication
(10) Pub. No.: US 2009/0129084 A1
(43) Pub. Date: May 21, 2009

(54) Optical device for altering light shape and light source module comprising same

(75) Inventor: Chih-Jen Tsao, Taipei (TW)

Correspondence Address: REED SMITH LLP, Suite 1400, 3110 Fairview Park Drive, Falls Church, VA, 22042, US

(73) Assignee: Prodisc Technology Inc.

(21) Appl. No.: 12/216,440

(22) Filed: Jul. 3, 2008

(30) Foreign Application Priority Data
Nov. 15, 2007 (TW) 096143304

(51) Int. Cl. F21V 13/04; F21V 7/00; G02B 27/09; F21V 5/04

(52) U.S. Cl. 362/244; 362/347; 359/668

(57) ABSTRACT

An optical device and a light source module comprising the same are disclosed. The optical device comprises a lens unit having a first area for adjusting a light shape in a first direction and a second area for adjusting a light shape in a second direction. The lens unit and a light-emitting element of the optical device can be arranged into an array to form a light source module. The combined light shape and light shape area of light emitted from the light source module is the sum of light shapes of light emitted from individual lens units.

### BACKGROUND OF THE INVENTION

1. Technical Field

The present invention relates to an optical device and a light source module comprising the same. More particularly, the present invention relates to an optical device for altering light shape and a light source module comprising the same.

2. Description of Related Art

FIG. 1 shows a light intensity distribution of a conventional light-emitting diode light source. As shown in FIG. 1, the light source has the following shortcomings due to its light intensity distribution. First, the energy is unduly concentrated at the center. Further, the uniformity of light over the illuminated area is poor, and illumination decreases at the corners. In addition, this type of light source is not suitable for road lighting because the illuminated area of the light source is not rectangular. Moreover, if the wide-angle light emitted from such a light source is not properly collected, the utilization rate and brightness of light emitted from the light source tend to decrease.

Taiwan Patent No. M296481 discloses a lighting module comprising a lens seat and a light-emitting element, wherein the lens seat includes a base surface adjacent to the light-emitting element, a light-emitting surface spaced from the base surface, an annular surrounding surface between the light-emitting surface and the base surface, and an inner groove surface concavely formed on the base surface towards the light-emitting surface and defining a light source assembly groove. The light-emitting surface has a first embossed area disposed along a first line and a second embossed area disposed along a second line, wherein the first and the second lines are perpendicular to each other, and the first and the second embossed areas intersect each other perpendicularly. By providing the light-emitting surface with embossed areas projecting in perpendicular directions, a virtually circular light shape of light emitted from the light-emitting element is altered into an elliptical shape, thereby broadening the application of the lighting module.

Taiwan Patent No. M290967 discloses a lighting apparatus for increasing light intensity and uniformity thereof. The lighting apparatus comprises a base plate, a peripheral wall extending downwards from an outer periphery of the base plate, at least one light source module disposed on an inner surface of the peripheral wall for emitting light, and a reflecting plate disposed on a lower surface of the base plate. The reflecting plate has a plurality of optically reflective surfaces formed on a lower surface thereof at intervals, for reflecting light emitted from the light source module so that the reflected light is projected downwards from and substantially perpendicular to the base plate, thereby producing a narrower and more concentrated projection angle so as to increase light intensity as well as uniformity thereof.

Taiwan Patent No. 1273858 discloses a light-emitting diode cluster light bulb. The light-emitting diode cluster light bulb includes a plurality of diode light bulb packages, a control circuit module, and a housing. The plurality of diode light bulb packages include a heat conducting/dissipating module and a light-emitting diode module. The control circuit module is used to control the diode light bulb packages. The housing is used to accommodate the diode light bulb packages and the control circuit module. When the light-emitting diode cluster light bulb is coupled to a power source, the control circuit module selectively controls the light-emitting modules to emit light. Furthermore, heat generated by each of the light-emitting diode modules while emitting light is conducted and dissipated through the heat conducting/dissipating module corresponding to each said light-emitting module.

Taiwan Patent No. 1273858 discloses a light-emitting diode cluster which increases light emitting efficiency by improving heat dissipation. U.S. Pat. No. 5,515,253 discloses a light-emitting diode module in which a lens unit includes a refractor. The refractor is provided with a plurality of raised portions on a rear side thereof, and a plurality of concave lenses and a plurality of convex lenses on a front side thereof. The light source module can emit light which has no shadow areas.

U.S. Pat. No. 7,172,319 discloses a light-collecting structure comprising a parabolic surface and a conical surface. The structure is capable of collecting virtually complete light emitted from a light source such as a light-emitting diode.

In the above-cited inventions, Taiwan Patent No. M296481 only discloses a lighting module for changing a circular illuminated area into an elliptical illuminated area; Taiwan Patent No. M290967 only discloses a lighting apparatus for increasing light intensity and uniformity thereof, wherein the lighting apparatus cannot alter a light shape of emitted light; the light source module disclosed in U.S. Pat. No. 5,515,253 can only increases uniformity of emitted light; and the light-collecting structure disclosed in U.S. Pat. No. 7,172,319, wherein no mention is made regarding increasing uniformity of light, cannot alter light shape.

Therefore, it is an objective of the present invention to provide an optical device for altering light shape and increasing a utilization rate of incident light and a light source module comprising the same.

### SUMMARY OF THE INVENTION

The present invention discloses an optical device for altering light shape and a light source module comprising the same.

The present invention also discloses an optical device for increasing a utilization rate of incident light and a light source module comprising the same. The present invention further discloses an optical device for increasing light uniformity on an illuminated area and a light source module comprising the same.

The present invention discloses a light source module comprising a plurality of lens units and a plurality of light-emitting elements arranged into an array, wherein a light shape and a total illuminated area of light emitted from the module is the sum of a light shape and an illuminated area of light emitted from each of the lens units.

The present invention also discloses a light source module comprising a plurality of lens units and a plurality of light-emitting elements arranged into an array, for reducing complexity of product structure and increasing precision in product assembly.

The present invention further discloses a light source module comprising a plurality of lens units and a plurality of light-emitting elements arranged into an array, for altering a light shape of light emitted from the light source module in order to meet the requirements for road lighting.

The present invention discloses an optical device for altering light shape and a light source module comprising the same. The optical device comprises a lens unit having a first area for adjusting a light shape in a first direction and a second area for adjusting a light shape in a second direction. The first direction and the second direction have an included angle between 70° and 110°.

The present invention further discloses a light source module for altering light shape comprising: a plurality of light-emitting elements and a plurality of lens units, wherein the plurality of lens units are arranged into an array and disposed correspondingly above the plurality of light-emitting elements. Each of the lens units has a first area for adjusting light shape in a first direction, and a second area for adjusting light shape in a second direction, wherein the first direction and the second direction have an included angle between 70° and 110°. The combined light shape of light emitted from the lens unit array is the sum of a light shape of light emitted from each of the lens units.

### BRIEF DESCRIPTION OF THE DRAWINGS

FIG. 1 shows a light shape of a conventional light source.

FIG. 2 illustrates an optical device according to the present invention.

FIG. 3 illustrates a lens unit of the optical device according to the present invention.

FIG. 4 is a side view of the lens unit and a light-emitting element according to the present invention.

FIG. 5 illustrates a lens unit array according to the present invention.

FIG. 6 illustrates a light source module according to the present invention.

FIG. 7 shows a light intensity distribution of the light source module according to the present invention.

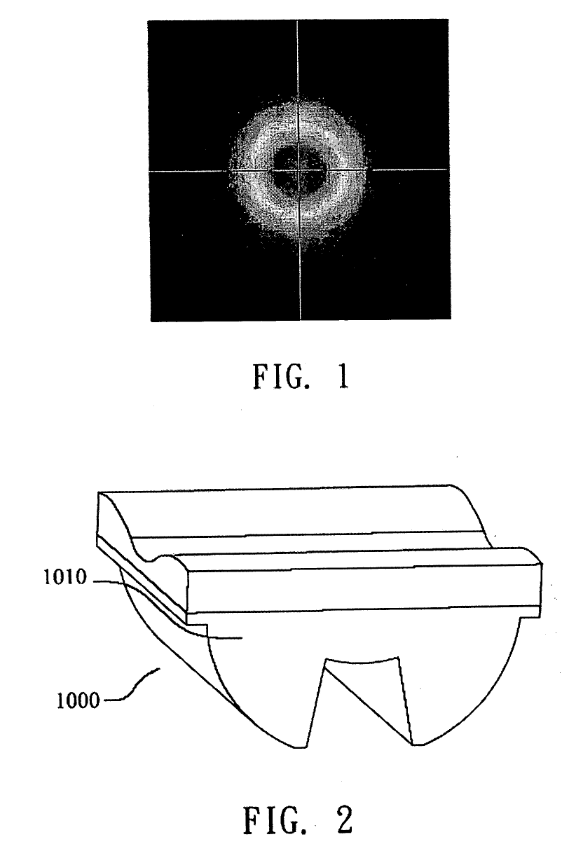

### DETAILED DESCRIPTION OF THE PREFERRED EMBODIMENT

The features of the present invention will be best understood by reference to the following detailed description of the preferred embodiments in conjunction with the accompanying drawings. It is understood that all the preferred embodiments presented herein are for illustrative purposes only. The present invention may be widely applied in embodiments other than those explained herein and illustrated in the accompanying drawings, and is not limited to any embodiments. The scope of the present invention is defined by the appended Claims and equivalents thereof.

The present invention discloses an optical device comprising a lens unit, wherein the lens unit has a first area and a second area for adjusting a light shape it emits.

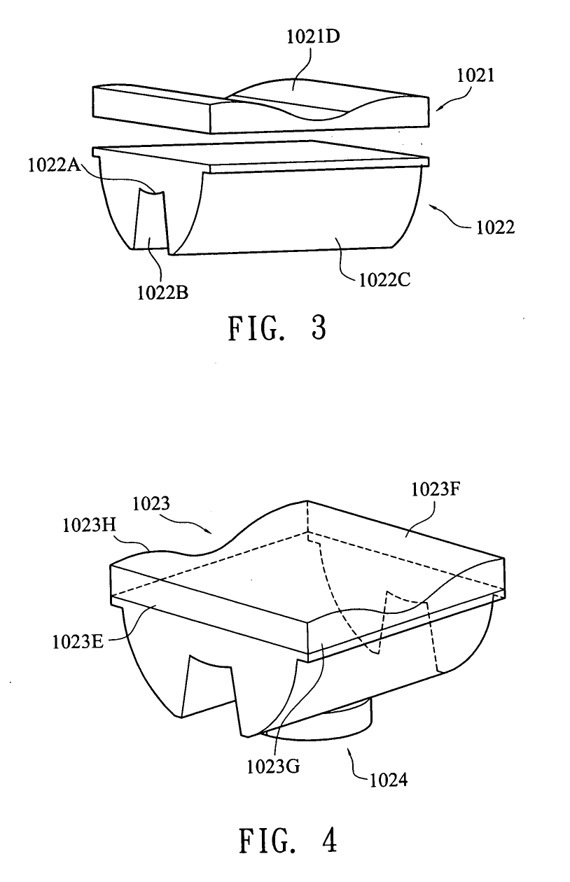

As shown in FIG. 2, an optical device 1000 according to an embodiment of the present invention includes a lens unit 1010. Referring to FIG. 3, the lens unit 1010 has a first area 1022 for adjusting a light shape of an illuminated area in a first direction, and a second area 1021 for adjusting a light shape of an illuminated area in a second direction. The first direction and the second direction have an included angle between 70° and 110°. In a preferred embodiment of the present invention, the first direction and the second direction have an included angle of 90°.

Referring to FIGS. 2 and 3, a cross-sectional view of the lens unit 1010 shows that the first area 1022 of the lens unit 1010 has an A surface 1022A, a B surface 1022B and a first curved surface 1022C, for adjusting a light shape of an illuminated area in the first direction. The A surface 1022A and the B surface 1022B constitute a concave space in the first area 1022 of the lens unit, wherein curvatures of the A surface 1022A and the B surface 1022B are determined with computer simulation for adjusting a light shape of an illuminated area in the first direction. The first curved surface 1022C of the first area 1022 of the lens unit defines an outer surface of the first area 1022 of the lens unit, wherein a curvature of the first curved surface 1022C is determined with computer simulation for adjusting a light shape of an illuminated area in the first direction. In another preferred embodiment, the curvature of the first curved surface 1022C is designed to generate total reflection of incident light. As such, the first curved surface 1022C can be used to collect incident light with a large incident angle, thereby increasing the utilization rate of incident light. In yet another preferred embodiment of the present invention, the first curved surface 1022C is coated to generate total reflection of incident light.

In still another embodiment of the present invention, the lens unit structure that constitutes the B surface 1022B and the first curved surface 1022C in FIG. 2 is omitted, and a reflective element (not shown) is added. The reflective element is a solid or hollow block with a curved surface facing the first curved surface 1022C whose curvature is designed to reflect incident light, so as to collect incident light with a large incident angle in the optical device, thereby increasing the utilization rate of incident light. In still another preferred embodiment, the reflective element is capable of totally reflecting an incident light.

In another embodiment of the present invention, a reflective element (not shown) is added below the structure of the first curved surface 1022C in FIG. 3, wherein the reflective element has a curved surface facing the first curved surface 1022C whose curvature is designed to reflect incident light, thereby increasing the reflection fraction of incident light and enhancing the light-emitting efficiency of the optical device.

In another preferred embodiment of the present invention, the A surface 1022A, the B surface 1022B, the first curved surface 1022C or the second curved surface 1021D in FIG. 3 is a linear Fresnel lens structure or a lenticular lens structure, whose light condensing properties can be used to optimize light shape, to reduce the weight of the optical device, and to downsize the lens unit.

Referring to FIGS. 2 and 3, the second area 1021 of the lens unit has a second curved surface 1021D for adjusting a light shape of an illuminated area in the second direction, wherein a curvature of the second curved surface is determined with computer simulation and the curved surface of the second area 1021 of the lens unit has a periodic variation. In an embodiment of the present invention, incident light is aligned with a convex portion of the second curved surface 1021D. In another preferred embodiment, incident light is aligned with a concave portion of the second curved surface 1021 D to produce a stronger front light.

In a preferred embodiment of the present invention, a surface of the lens unit receives UV-cut and/or IR-cut treatment to protect internal elements from the interference of ultra-violet and/or infrared rays. In a preferred embodiment, the surface of the lens unit has a high transmittance coating for increasing light-emitting efficiency of the optical device. In another preferred embodiment, the surface of the lens unit has a color coating in place of a color filter. In yet another embodiment, the lens unit is made of a material having such properties as UV-cut and/or IR-cut and/or high transmittance and/or being capable of absorbing a specific color light, and therefore does not need to be coated.

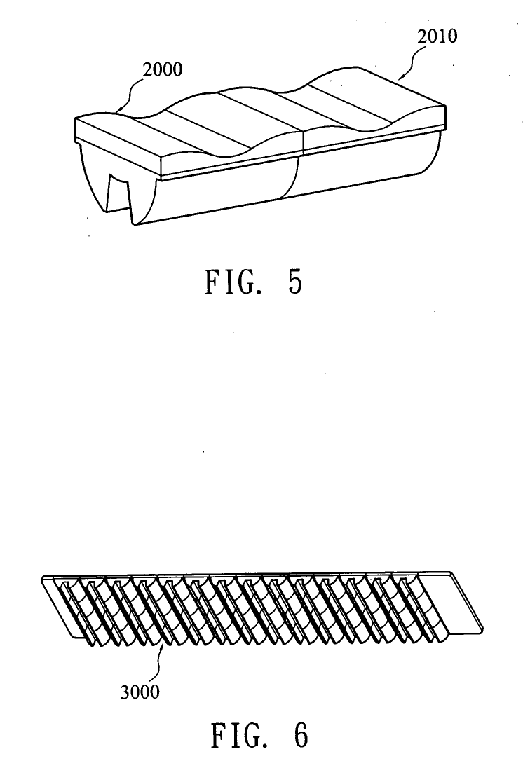

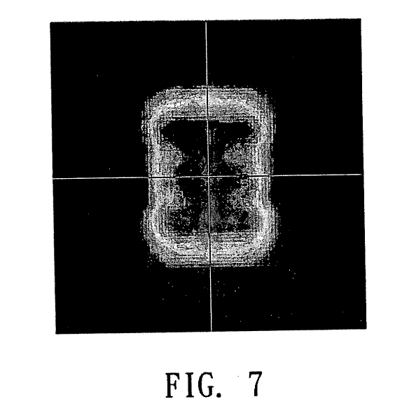

The above-mentioned plurality of optical devices can be connected mutually to form an array having a single row or a plurality of rows, and cooperate with a light-emitting light source corresponding to the lens unit to form a light source module. As shown in FIG. 4, a light source module has a lens unit 1023 and a light-emitting element 1024 corresponding to the lens unit, wherein an E surface 1023E and an F surface 1023F are parallel to each other, and a G surface 1023G and an H surface 1023H are also parallel to each other. When a plurality of lens units are combined to form an array, the curved surface of each of the plurality of lens units form a smooth continuous surface. FIG. 7 shows a simulation result of light shape and light intensity. A light source module for the simulation comprises a first light-emitting element and a first lens unit; a second light-emitting element and a second lens unit; and a third light-emitting element and a third lens unit. As shown in FIGS. 4 and 5 and taking a first lens unit 2000 and a second lens unit 2010 for example, an F surface of the lens unit 2000 and an E surface of the second lens unit 2010 are coupled to each other; and the second lens unit and a third lens unit are couple together in a similar way. Referring to FIG. 7, for the assembled light source module, a light intensity distribution of light emitted from each single lens unit is virtually identical to that of said single lens unit before being assembled into the module. However, an intensity of light emitted from the module is twice as high as that of each single lens unit. In another embodiment, a light source module also comprises a plurality of light-emitting elements and a plurality of lens units, but an H surface of a lens unit is coupled to a G surface of another lens unit. According to a simulation result of light shape and light intensity, for this light source module, a light intensity distribution of light emitted from each single lens unit is virtually identical to that of said single lens unit before being assembled into the module. However, an intensity of light emitted from the light source module is twice as high as that of each single lens unit.

Referring to FIG. 6, a light source module 3000 is disclosed in another preferred embodiment of the present invention. The light source module 3000 comprises an N×M array of light-emitting elements and lens units, wherein each of the light-emitting elements corresponds to a lens unit. The light source module 3000 includes M rows of light-emitting elements and corresponding lens units in a cross-section along a certain direction, wherein each of the M rows includes N light-emitting elements and N corresponding lens units to form an N×M array of light-emitting elements and lens units. Each of the light-emitting elements is coupled to and corresponds to a lens unit as in the formation of arrays in the above-mentioned embodiments. The light-emitting elements are arranged in such locations and with such a density that enough space is reserved for accommodating the corresponding lens units, so that, in a simulation result of light shape and light intensity, an intensity of light emitted from the light source module 3000 is N×M times as high as that of each single lens unit, while a light shape and an illuminated area of light emitted from the light source module 3000 is equivalent to the sum of a light shape and an illuminated area of light emitted from each single lens unit. Furthermore, the light source module 3000 is composed of a single type of light-emitting elements and lens units, therefore providing such advantages as easy assembly and maintenance, lower complexity in product structure, and an increased precision in product assembly. In another embodiment of the present invention, the above-mentioned lens unit array arrangement is not limited in shape, and can take the shape of, for example, a rectangle, a diamond and a polygon.

In yet another embodiment, the above-mentioned light-emitting element can be any light source that can be arranged into an array. In a preferred embodiment, the light-emitting element is a light-emitting diode.

Although the present invention has been explained in relation to its preferred embodiments, it is to be understood that the preferred embodiments are not intended to limit the scope of the present invention, which is defined by the appended Claims and equivalents thereof. Alterations and modifications can be made by those skilled in the art without departing from the spirit and scope of the present invention. Such alterations and modifications should be construed as equivalent variations or designs made according to the spirit of the present invention and are encompassed by the appended Claims.

What is claimed is:

1. An optical device for altering a light shape, comprising a lens unit which has a first area for adjusting the light shape in a first direction and a second area for adjusting the light shape in a second direction, wherein the first direction and the second direction have an included angle between 70° and 110°.

2. The optical device as claimed in claim 1, wherein the first direction and the second direction are orthogonal.

3. The optical device as claimed in claim 1, wherein the first area at least comprises a plurality of first curved surfaces for adjusting the light shape in the first direction.

4. The optical device as claimed in claim 3, wherein the first curved surfaces are used to generate a reflection.

5. The optical device as claimed in claim 4, wherein the first curved surfaces are used to generate a total reflection.

6. The optical device as claimed in claim 3, further comprising a reflective element for adjusting the light shape in the first direction.

7. The optical device as claimed in claim 1, wherein the second area at least comprises a second curved surface for adjusting the light shape in the second direction.

8. The optical device as claimed in claim 7, wherein the second curved surface has a periodic variation.

9. The optical device as claimed in claim 7, wherein a highest point or a lowest point of the second curved surface is aligned with an incident light.

10. The optical device as claimed in claim 1, wherein the first area further comprises a reflective surface for adjusting the light shape in the first direction.

11. The optical device as claimed in claim 10, wherein the reflective surface includes a coating or a plurality of coatings.

12. The optical device as claimed in claim 1, wherein a surface of the lens unit is a linear Fresnel structure or a lenticular structure.

13. The optical device as claimed in claim 1, wherein the lens unit has a property of UV-cut, and/or IR-cut, and/or high transmittance.

14. The optical device as claimed in claim 1, wherein the lens unit further comprises a color filter or a color coating.

15. A light source module for altering a light shape, comprising:
a plurality of light-emitting elements; and
a plurality of lens units, disposed above the light-emitting elements correspondingly and arranged into an array, wherein each of the plurality of lens units has a first area for adjusting the light shape of a light emitted from the corresponding light-emitting element in a first direction; and a second area for adjusting the light shape of the light emitted from the corresponding light-emitting element in a second direction; wherein the first direction and the second direction have an included angle between 70° and 110°, and a combined light shape of light emitted from the lens unit array is a sum of a light shape of the light emitted from each of the lens units.

16. The light source module as claimed in claim 15, wherein the first direction and the second direction are orthogonal.

17. The light source module as claimed in claim 15, wherein the first area at least comprises a plurality of first curved surfaces for adjusting the light shape of the light emitted in the first direction.

18. The light source module as claimed in claim 15, wherein the second area at least comprises a second curved surface for adjusting the light shape of the light emitted in the second direction.

19. The light source module as claimed in claim 18, wherein each of the plurality of light-emitting elements is aligned with a highest point or a lowest point of the second curved surface of the corresponding lens unit.

20. The light source module as claimed in claim 15, wherein the first area furthers comprises a reflective surface for adjusting the light shape of the light emitted in the first direction.

21. The light source module as claimed in claim 15, wherein the light-emitting elements are light-emitting diodes.
